(19) United States
(12) Patent Application Publication
(10) Pub. No.: US 2016/0098793 A1
(43) Pub. Date: Apr. 7, 2016

(54) SYSTEM FOR STRUCTURING A MORTGAGE INTO LAYERS

(71) Applicant: Glen M. BARCLAY, Thousand Oaks, CA (US)

(72) Inventor: Glen M. BARCLAY, Thousand Oaks, CA (US)

(21) Appl. No.: 14/874,906

(22) Filed: Oct. 5, 2015

Related U.S. Application Data
(60) Provisional application No. 62/059,224, filed on Oct. 3, 2014.

(51) Int. Cl. G06Q 40/02; G06Q 50/16

(52) U.S. Cl. CPC G06Q 40/025; G06Q 50/16

(57) ABSTRACT

A system for computing mortgage risk by defined layers and pricing each additional risk unit by layer attributes. The process includes computing risk scores that result in computing risk adjusted interest rates.

### CLAIM FOR PRIORITY

The present application claims benefit and priority of U.S. Provisional Application No. 62/059,224 filed on Oct. 13, 2014 and hereby incorporates by reference in its entirety the subject matter therein.

### BACKGROUND

1. Field of the Invention

The present invention relates to a system for computing mortgage risk layers, risk scores, and risk adjusted interest rates.

Embodiments of the invention allow lenders to offer mortgage products tailored to their specific capital structure and based on clearly defined risk characteristics. The layering process allows for pricing at specified risk levels that is transparent and provides insight into incremental risk exposure. This process clearly defines the required compensation for each unit of additional risk.

The present invention is a new system which provides these desirable benefits and features.

2. Description of the Prior Art

Most loan originators price their loans based on Agency pricing matrices. This is fine for originators that sell their originations to the Agencies. For originators that keep loans on their balance sheet it can be challenging to price their loan products effectively. There are many factors to consider when pricing mortgage products. The future path of interest rates is the least important in the pricing process as effective tools exist for hedging this component. The more troublesome components to calibrate are default and loss attributes. They are the key drivers of profitability and loss for an originators portfolio. Unfortunately most pricing models require complex and opaque processes. Discounted cash flow analysis (DCF) and Monte Carlo simulation are beyond the capabilities of most originators. In addition, they require input assumptions that are difficult to substantiate.

### SUMMARY OF THE INVENTION

The following presents a simplified summary of several embodiments of the invention in order to provide a basic understanding of such embodiments. This summary is not an extensive overview of all contemplated embodiments of the invention, and is intended to neither identify key or critical elements of all embodiments, nor delineate the scope of any or all embodiments. Its purpose is to present some concepts of one or more embodiments in a simplified form as a prelude to the more detailed description that is presented later.

Defining risk layers within a given mortgage product provides transparency to risk based pricing. Default rate and loss severities are readily available and published by many sources. When applied to a risk layer structure they provide clarity to the required risk premium per unit of risk. The attributes needed to compute mortgage risk fall into four categories including property attributes, borrower attributes, loan product attributes, and lender attributes. Each attribute of property, borrower, and loan contribute to a probability of default and corresponding default rate as well as an expected loss severity given default. The lender attributes drive interest rate derivation specific to the firm's economics. Lender attributes include a reference rate and a required margin. The reference rate represents the firms expected cost of capital over the life of the loan product while the margin represents the firms required return and capital structure expressed in basis points. These are critical components as they relate to firm specific risk based pricing. Capital structure, cost of capital, and liquidity can vary greatly between firms and have a direct impact on risk based pricing.

In one embodiment, a system configured for computing mortgage risk layers, risk scores, and risk adjusted interest rates. The system includes a memory, processor, controller and storage configured to issue a plurality of instructions . The instructions direct the processor to receive property attributes, borrower attributes, loan product attributes, and lender attributes. The instructions further direct the processor to compute risk layers, risk scores, and risk adjusted interest rates. The instructions direct the processor to store computation results in non transitory storage medium.

In another embodiment, a computer program product includes instructions operable to cause the server computing device to receive property attributes, borrower attributes, loan product attributes, and lender attributes. The computer program product includes instructions operable to cause the server computing device to compute risk layers, risk scores, and risk adjusted interest rates. The computer program product includes instructions operable to cause the server computing device to store computation results in non transitory storage medium.

In another embodiment, a computer implemented method of computing mortgage risk layers, risk scores, and risk adjusted interest rates. The method implemented by a computer system comprising a processor, memory, controller, non transitory storage media configured with specific instructions, to receive property attributes, borrower attributes, loan product attributes, and lender attributes; compute risk layers, risk scores, and risk adjusted interest rates, store computation results in non transitory storage medium.

### DESCRIPTION OF THE DRAWINGS

The objectives and advantages of the invention will become apparent upon consideration of the following detailed description, taken in conjunction with the accompanying drawings, in which like reference characters refer to like parts throughout, and in which:

FIG. 1 is a diagram depicting a system for implementing the process,

FIG. 2 is a diagram of steps to compute risk layers, risk scores, and interest rates,

### DETAILED DESCRIPTION OF THE PREFERRED EMBODIMENTS

Embodiments of the invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

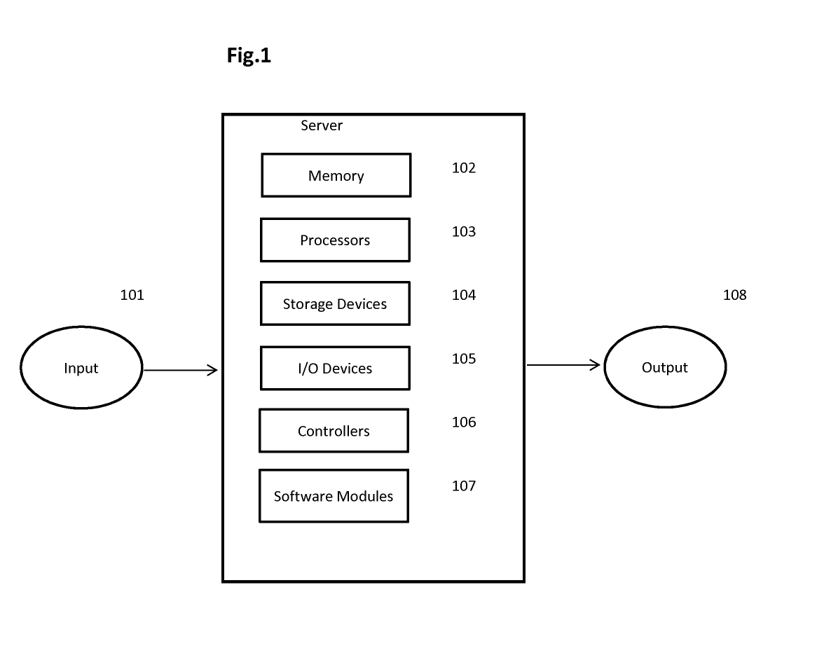

FIG. 1 is a block diagram depicting a system for computing mortgage risk layering. The system includes a server comprising memory 102, processors 103, storage devices 104, input output devices 105, controllers 106, and software modules 107. The controller directs the hardware and software components to perform functions to compute mortgage risk layering, risk scores, and risk adjusted interest rates. The server receives input 101 from input devices 105 and reads the data into memory 102 and stores data to non transitory storage 104. The controllers 106 direct software 107 to process instructions with processors 103. The software 107 in conjunction with memory 102, processors 103, and non transitory storage 104 manipulate data inputs and compute parameters to generate risk layers, risk scores, and risk adjusted interest rates while saving the computation results to non-transitory storage.

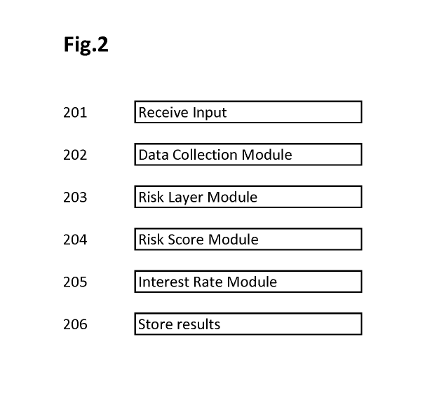

The controllers 106 of FIG. 1 may include one or more computer processors (e.g., a central processing unit (CPU)) and/or one or more microcomputers for performing the processors and/or functions described herein. For instance, the controllers 106 may be specifically configured to perform the processes and method associated with the process flow of FIG. 2. The one or more processors and/or one or more microcomputers include, in some embodiments, a built-in memory which includes software (e.g., firmware) and/or computer-executable instructions. In this way, the one or more processors and/or one or more microcomputers of the controller may be specifically and specially programmed the processes and/or algorithms described herein to thereby accomplish the one or more steps and/or processes in the present application. While not expressly disclosed throughout the present application, it should be understood that the controllers 106 is intended to be the means by which many of the processes, methods, and functions described herein are achieved.

Additionally, the controllers 106 is connected to: I/O devices 105 for inputting and outputting information for controlling operation of the system; the I/O devices 105 may display images of the computed output, such as a diagram representing the computed risk layers and the like.

FIG. 2 is a diagram detailing the operational steps for computing the mortgage risk layering process. Step 201 receives input attributes for property, borrower, loan product, and lender. The attributes are stored in non transitory storage and memory for use in the risk layer module, risk score module, and interest rate module. Property attributes may include items such as property value, property type, occupancy and location. Borrower attributes may include demographic, credit, and employment information. Loan product attributes may include items such as loan type, purpose, lien position, LTV, CLTV, and maturity. Lender attributes may include items such as required margin and cost of capital. Step 202 activates the risk layer module. This module computes the number of risk layers and thickness of each layer referred to as the layer width. Each risk layer is assigned a priority and an attachment point. Each attachment point represents the coordinates of each layer in the collection of risk layers. The risk layers may be stored as a logical array in memory or as records in a non transitory storage medium. Step 203 activates the risk score module. This module utilizes the attributes from Step 201 to compute default vectors and loss severity vectors. The default vector is range of default rates based on the attributes for property, borrower, and loan product. The range of default rates span a scale from 0% to 100%. The loss severity vector is a range of values from less than 0% to greater than 100%. Loss severity rates represent the intensity of a given default event. The vector values are applied to each corresponding risk layer to compute an expected loss rate and corresponding risk score for each layer. The expected loss is derived using default and loss vectors for each layer and represents the loss rate for each layer given a default event. Step 204 activates the interest rate module. This module computes a risk adjusted interest rate for each layer utilizing the results from Step 203 and base rate from Step 201. The base rate is used as starting point for computing a risk adjusted rate and is derived from the lender attributes. This module computes a composite rate for each layer as a weighted average of each layer and previous layers. Step 205 stores the computation results in a non transitory storage medium that can be output to various devices. Once all computations are complete, a lender may use the results to price a given credit amount or credit layers.

It should be understood that the foregoing description is merely illustrative of the invention. Numerous alternative embodiments within the scope of the appended claims will be apparent to those of ordinary skill in the art.

It will be understood that any suitable computer-readable medium may be utilized in performing any of the steps, processes, and methods described herein. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the invention, however, the computer-readable medium may be transitory, such as, for example, a propagation signal including computer-executable program code portions embodied therein.

One or more computer-executable program code portions for carrying out operations of the invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the invention are written in conventional procedural programming languages, such as the “C” programming languages and/or similar programming languages. The computer program code may alternatively or additionally be written in one or more multi-paradigm programming languages, such as, for example, F#.

Some embodiments of the invention are described herein above with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the invention.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed:

1. A system configured for computing one or more of mortgage risk lavers, risk scores, and computing interest rates, the system comprising:
a controller configured to control one or more components of the system;
a memory operably connected to the controller and that is controllable by the controller;
wherein the controller controls to compute a plurality of risk layers, wherein each of the risk layers corresponds with priorities and attachment points of underlying property value.

2. The system according to claim 1, wherein the controller is further configured to receive input associated with computing mortgage risk layers wherein loan attributes include a loan type, loan term, and loan purpose.

3. The system according to claim 1, wherein the controller is further configured to receive input associated with computing mortgage risk layers wherein property attributes include property type, property value, location, and occupancy.

4. The system according to claim 1, wherein the controller is further configured to receive input associated with computing mortgage risk layers wherein borrower attributes include credit score and credit history.

5. The system according to claim 1, wherein the controller is further configured to receive input associated with computing mortgage risk layers wherein lender attributes include required margin and reference rate.

6. The system according to claim 1, wherein the controller is further configured to computer a default rate vector.

7. The system according to claim 1, wherein the controller is further configured to compute a loss severity vector.

8. The system according to claim 5, wherein the controller is further configured to compute a base interest rate.

9. The system according to claim 1, wherein the controller is further configured to computer a first attachment point.

10. The system according to claim 1, wherein the controller is further configured to compute a risk layer width.

11. The system according to claim 1, wherein the controller is further configured to computer a default rate for each risk layer.

12. The system according to claim 1, wherein the controller is further configured to computer a loss severity for each risk layer.

13. The system according to claim 1, wherein the controller is further configured to compute an expected loss rate for each risk layer.

14. The system according to claim 1, wherein the controller is further configured to computer a risk score for each risk layer of the risk layers.

15. The system according to claim 1, wherein the controller is further configured to computer a risk adjusted interest rate for each layer of the risk layers.

16. The system according to claim 1, wherein the controller is further configured to computer a composite interest rate for each layer of the risk layers.

17. The system according to claim 1, wherein the controller is further configured to store computation results to a non-transitory storage medium.

18. The system according to claim 1, wherein the controller is further configured to apply composite rates to a credit layer.

19. A computer program product for computing risk layers, risk scores, and risk adjusted interest rates comprising computer-executable processing instructions stored in a non-transitory storage medium, such that when upon execution of the processing instructions by one or more processors associated with a controller, is configured to perform the following:
compute a plurality of risk layers, wherein each of the risk layers corresponds with priorities and attachment points of one or more security interests or liens in a property.

20. A computer-implemented method for mortgage risk analysis including computing risk layers, risk scores, and risk adjusted interest rates, the method comprising:
computing, via a controller implemented by one or more processors, a plurality of risk layers, wherein each of the risk layers corresponds with priorities and attachment points of one or more security interests or liens in a property.
